(19) United States
(12) Patent Application Publication
(10) Pub. No.: US 2021/0060477 A1
(43) Pub. Date: Mar. 4, 2021

(54) PRESSURE-SWING ADSORPTION PROCESS FOR SEPARATING ACID GASES FROM NATURAL GAS

(71) Applicant: Chevron U.S.A. Inc., San Ramon, CA (US)

(72) Inventor: Joshua Allen Thompson, Richmond, CA (US)

(21) Appl. No.: 16/556,382

(22) Filed: Aug. 30, 2019

(51) Int. Cl. B01D 53/053; C10L 3/10

(52) U.S. Cl. CPC B01D 53/053; C10L 3/103; C10L 3/104; B01D 2253/1085; B01D 2256/245; B01D 2257/302; C10L 2290/542; B01D 2259/4066; B01D 2259/402; B01D 2259/40041; B01D 2259/40075; C10L 2200/0286; C10L 2200/0263; B01D 2257/504

(57) ABSTRACT

Disclosed are methods for removing acid gas from a feed stream of natural gas including acid gas, methane and ethane. The methods include alternating input of the feed stream between at least two beds of adsorbent particles comprising zeolite SSZ-13 such that the feed stream contacts one of the at least two beds at a given time in an adsorption step and a tail gas stream is simultaneously vented from another of the at least two beds in a desorption step. The contact occurs at a feed pressure of from about 50 to about 1000 psia for a sufficient period of time to preferentially adsorb acid gas from the feed stream. A product gas stream is produced containing no greater than about 2 mol % carbon dioxide and at least about 65 mol % of methane recovered from the feed stream and at least about 25 mol % of ethane recovered from the feed stream. The feed stream is input at a feed end of each bed. The product gas stream is removed from a product end of each bed. The tail gas stream is vented from the feed end of each bed. The methods require lower vacuum power consumption and allow improved hydrocarbon recoveries compared with known methods.

### FIELD

The present disclosure relates to methods for treating methane-containing gas mixtures involving the use of adsorbent zeolite particles to adsorb acid gases from the gas mixtures.

### BACKGROUND

Natural gas typically requires treatment to remove acid gas contamination including carbon dioxide (CO₂) and hydrogen sulfide (H₂S) before utilization of the natural gas. As natural gas production continues to grow in remote areas and in gas fields containing acid gases, there is a need to treat natural gas produced from these fields using efficient methods to remove such contaminants. To treat acid gases, aqueous amine absorption is the standard technology because of high recovery of hydrocarbons and efficient energy use. However, amine absorption technology may not be feasible or practical when treating natural gas at the well head or at low flow rates. Amine absorption technology has issues associated with handling solvents required for regeneration and has poor economics in remote or offshore locations. Practical use of amine absorption technology would require absorption of acid gases at mild temperatures, heating the solvent to high temperatures to remove the acid gases in a stripping tower, and subsequent cooling of the solvent to return to the absorption unit. The natural gas product from the amine unit further requires a dehydration step to remove water for dew point control.

Pressure-swing adsorption (PSA) technology is an alternative technology for treating natural gas that uses a solid adsorbent material to remove acid gases. PSA technology operates by using an adsorbent material that removes a target adsorbate molecule from a gas mixture by preferential adsorption over other species in the gas mixture. Adsorption processes that remove CO₂ from gas streams typically use zeolite- or carbon-based adsorbent materials. The adsorbent can either function by equilibrium (thermodynamics) or kinetic (rate-based) separations. In principle, all adsorption processes utilize at least two steps: adsorption or uptake of the target molecule in the adsorbent; and desorption or removal of that same target molecule from the adsorbent. This may be achieved by changes in concentration, pressure, or temperature. In the case of PSA and vacuum-swing adsorption (VSA), pressure changes are used to regenerate the adsorbent. PSA does not require a dehydration step. PSA technology is able to treat natural gas containing acid gases without the need for on-site solvent regeneration and other issues associated with amine units.

It would be desirable to have a PSA process utilizing an adsorbent material which would require lower vacuum power consumption, and which would allow improved hydrocarbon recoveries as compared with known processes. Such a process would enable deployment and competitive use of PSA units for natural gas separations in expanded applications.

### SUMMARY

In one aspect, a method is provided for removing acid gas from a feed gas stream of natural gas including acid gas, methane and ethane. The method includes alternating input of the feed gas stream between at least two beds of adsorbent particles comprising zeolite SSZ-13 such that the feed gas stream contacts one of the at least two beds at a given time in an adsorption step and a tail gas stream is simultaneously vented from another of the at least two beds in a desorption step. The contact occurs at a feed pressure of from about 50 to about 1000 psia for a sufficient period of time to preferentially adsorb acid gas from the feed gas stream. A product gas stream is produced containing no greater than about 2 mol % carbon dioxide and at least about 65 mol % of methane recovered from the feed gas stream and at least about 25 mol % of ethane recovered from the feed gas stream. The feed gas stream is input at a feed end of each bed. The product gas stream is removed from a product end of each bed. The tail gas stream is vented from the feed end of each bed.

An additional embodiment is the use of an intermediate providing purge step rather than at the beginning or end of equilibration steps.

### DESCRIPTION OF THE DRAWINGS

These and other objects, features and advantages of the present invention will become better understood with reference to the following description, appended claims and accompanying drawings where:

FIGS. 1 and 2 are a schematic diagram illustrating a two bed PSA system and a corresponding bed interaction scheme, respectively, according to one exemplary embodiment.

FIGS. 3 and 4 are a schematic diagram illustrating a nine bed PSA system and a corresponding bed interaction scheme, respectively, according to one exemplary embodiment, referred to as “Process 2”.

FIG. 5 is a plot comparing XRD patterns of samples of Na-SSZ-13 pellets with Na-SSZ-13 powder.

FIG. 6 is a schematic diagram illustrating a dynamic column breakthrough (DCB) apparatus.

FIGS. 7-11 show the equilibrium adsorption results for CO₂, CH₄, C₂H₆, H₂O and H₂S, respectively, according to exemplary embodiments.

FIG. 12 is a plot of enthalpy of adsorption for each natural gas component on Na-SSZ-13 according to exemplary embodiments.

FIGS. 13-15 are representative breakthrough curves comparing experimental and simulation breakthrough behavior for Na-SSZ-13 according to exemplary embodiments.

FIGS. 16-17 show bed interaction scheme for other embodiments of a nine bed PSA system, referred to as “Process 3” and “Process 1”, respectively.

### DETAILED DESCRIPTION

The methods of the present disclosure use SSZ-13 zeolite particles as an adsorbent material in a PSA process for removing acid gas from natural gas streams. The acid gas can include carbon dioxide (CO₂), hydrogen sulfide (H₂S), carbonyl sulfide (COS), combinations thereof, and combinations thereof with water (H₂O). In one embodiment, the amount of hydrogen sulfide in the feed gas stream is from 0 to 1000 ppm.

SSZ-13 is a synthetic chabazite (a CHA type zeolite), described more fully in U.S. Pat. No. 4,544,538, issued Oct. 1, 1985 to Zones, the contents of which are incorporated herein by reference. A method for preparing SSZ-13 is disclosed in U.S. Pat. No. 8,007,764 (Miller et al.), the contents of which are incorporated herein by reference. In one embodiment, the SSZ-13 has a ratio of silica to alumina (also referred to as Si:Al ratio) of from 5 to 100. In one embodiment, the zeolite SSZ-13 has a cation as a framework ion. Suitable cations can include sodium, calcium, potassium, lithium, magnesium, and barium. In one embodiment, the cation is a sodium cation.

In one embodiment, acid gas is removed from a feed gas stream of natural gas including acid gas, methane and ethane. In one embodiment, the feed gas stream is alternately input between at least two beds of adsorbent particles comprising zeolite SSZ-13 such that the feed gas stream contacts one of the at least two beds at a given time. The feed gas stream is input at a feed end of each bed. In one embodiment, the feed gas stream has a flow rate of from 1 to 300 million standard cubic feet per day (MMSCFD) in an adsorption step. The adsorption step can occur at a temperature of from 20 to 80° C.

While the feed gas stream is contacting the adsorbent bed, the adsorbent bed is operating in the adsorption step. A tail gas stream is simultaneously vented from another of the at least two beds in a desorption step. The tail gas stream is vented from the feed end of each bed. The contact of the gas with the adsorbent particles (in the adsorption step) occurs at a feed pressure of from about 50 to about 1000 psia for a sufficient period of time to preferentially adsorb acid gas from the feed gas stream. As feed pressure is increased, the moles of ethane (C₂H₆) adsorbed onto the adsorbent per mass of the adsorbent decreases. A principle of PSA operations is that the adsorbent is fed at higher pressures, and the adsorbent bed is regenerated at a lower pressure. In processes using conventional adsorbents, C₂H₆ adsorbs more as pressure is increased, and during the desorption step, more C₂H₆ is lost because desorption occurs at the lower pressures of desorption. In embodiments of the present disclosure, because C₂H₆ adsorbs more at lower pressures, it is not lost in as great a quantity in the tail gas as in processes using conventional adsorbents due to the adsorption behavior of SSZ-13, demonstrated herein experimentally in Example 3. Thus, the potential recovery of the heavier hydrocarbon is increased in processes using SSZ-13 as the adsorbent.

A product gas stream is produced as a result of the adsorption step. The product gas stream is removed from a product end of each bed. The product gas stream contains no greater than about 2 mol % carbon dioxide and at least about 65 mol % of methane recovered from the feed gas stream and at least about 25 mol % of ethane recovered from the feed gas stream. In one embodiment, the product gas stream contains methane having a purity of at least about 95 mol % and ethane having a purity of at least about 3 mol % ethane. In one embodiment, the product gas stream contains no greater than about 50 ppm hydrogen sulfide. In one embodiment, the product gas stream contains no greater than about 4 ppm hydrogen sulfide.

In one embodiment, following the adsorption step in one of the at least two beds and simultaneous desorption step in another of the at least two beds, the pressure of the two beds is allowed to equalize. This can be done by means of a line connecting the product ends of the two beds at the end of the adsorption step and simultaneous desorption step. Following the desorption step, the bed having just completed the desorption step is repressurized by first equalizing in pressure with a second bed of at least two beds and then further repressurized by another gas stream. This further repressurization can be done by sending a slipstream of the product gas stream through the product end of the bed having just completed the desorption step. In another embodiment, the further repressurization can be done by utilizing the feed gas through the feed end of the bed having just completed the desorption step.

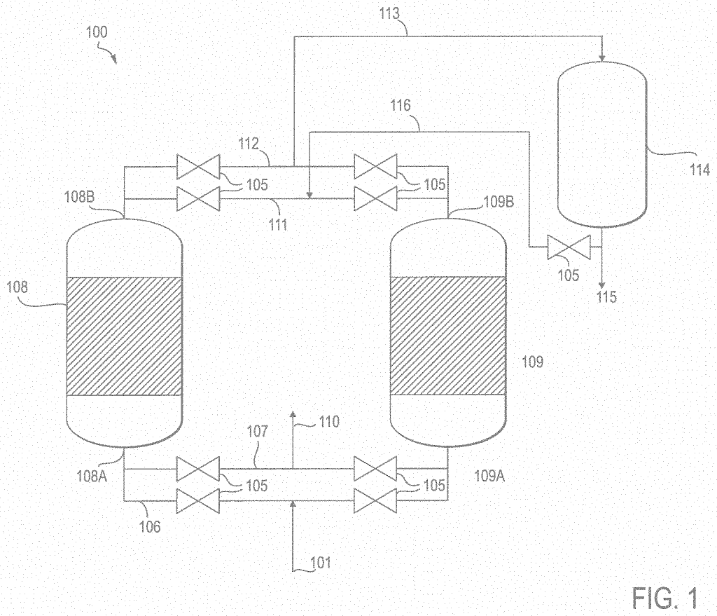

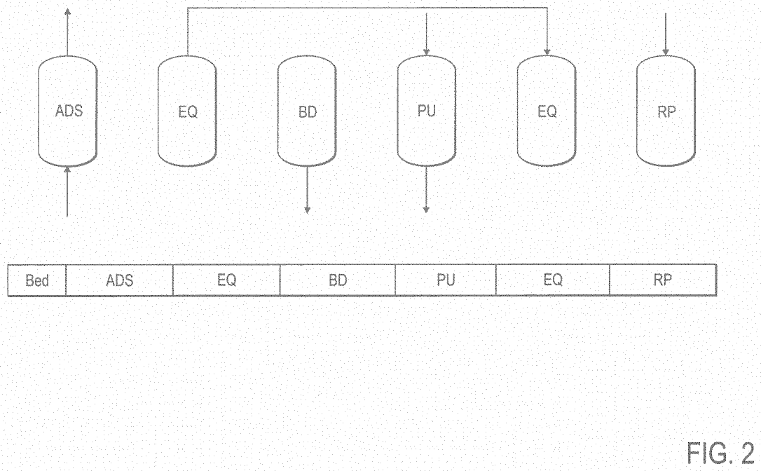

In one embodiment, two adsorbent beds are used. A PSA system 100 with two beds is shown in FIG. 1 with an adsorption cycle (bed interaction scheme) as shown in FIG. 2. Feed gas 101 is introduced into line 106 having block valves 105 therein. Line 106 connects the feed ends 108A and 109A of adsorption columns 108 and 109, respectively. Line 107 also connects the feed ends 108A and 109A of adsorption columns 108 and 109, respectively, and has an outlet for tail gas 110. Adsorption columns 108 and 109 have product ends 108B and 109B, respectively. Product ends 108B and 109B are connected by lines 111 and 112. Lines 111 and 112 include block valves 105. Line 112 is connected with line 113 which delivers gas to optional product gas buffer tank 114. The product gas buffer tank 114 allows controlled purging and repressurization steps. Product gas 115 can be provided from product gas buffer tank 114 (controlled by a block valve 105) through line 116 to line 111. FIG. 20 illustrates the sequence of steps that each of the adsorption columns cycles through. In one embodiment, adsorption columns 108 and 109 alternate, such that while one adsorption column, column 108, is operating in the adsorption step, the other adsorption column, column 109, is operating in the desorption step. Following the adsorption step in the first bed, the bed having just finished the adsorption step is depressurized through the product end of the bed, line 111, while feeding gas to the second bed having just completed the desorption step through the product end of the bed, line 112. When the pressures have equalized in the two beds, the first bed is then depressurized through the feed end of the bed from about 20 psia to about 1 psia, line 110, and the second bed is simultaneously repressurized using a product gas buffer tank 114 through line 116.

In one embodiment, five to nine adsorbent beds, preferably nine beds, are used and the adsorbent beds are controlled in such a way that each bed cycles through a sequence of operations, also referred to as steps, and the cycles of the four beds are synchronized with respect to one another. Increasing the number of beds and configuration of intermediate steps provides 20% or more increase in natural gas recovery while maintaining similar level of product purity. In particular, the combination of greater than 4 beds allows split feeding to multiple beds to increase time for breakthrough of gas impurities and increases the number of equalization steps from two to three that are incorporated into the PSA cycle. These combined factors produce the increased gas recovery and purity. Above nine beds, there will be diminishing returns in increase of gas recovery for each additional bed in the PSA cycle as greater than 90% is already reached with only nine beds and additional pressure equalization will recover less gas volumes on a per step basis above three equalization steps.

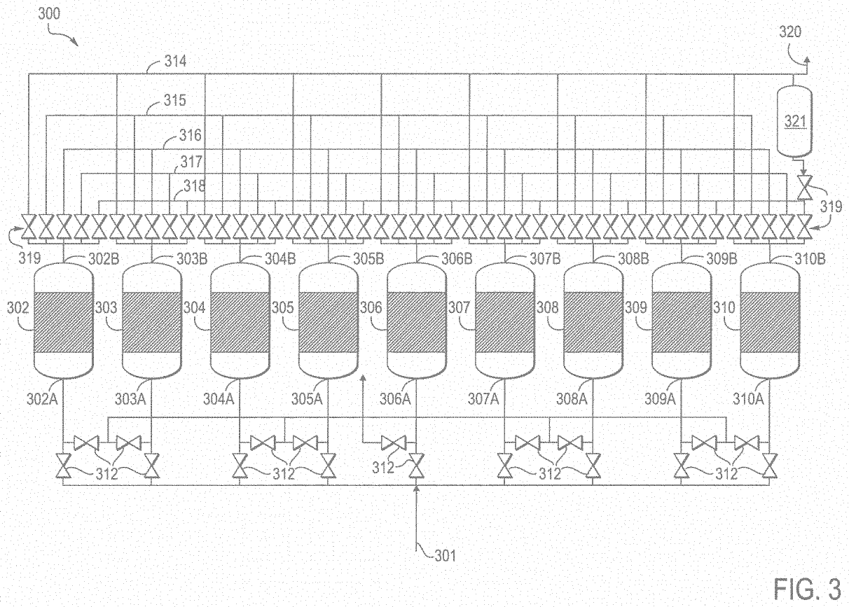

FIG. 3 illustrates such a system 300. The operation of system 300 is similar to the operation of the two-bed system 100. Feed gas 301 is introduced into line 311 having block valves 312 therein. Line 311 connects the feed ends 302A, 303A, 304A, 305A, 306A, 307A, 308A, 309A, and 310A of adsorption columns 302, 303, 304, 305, 306, 307, 308, 309, and 310, respectively. Line 311 also connects the feed ends 302A, 303A, 304A, 305A, 306A, 307A, 308A, 309A, and 310A of adsorption columns 302, 303, 304, 305, 306, 307, 308, 309, and 310, respectively, and has an outlet for tail gas 313. Adsorption columns 302, 303, 304, 305, 306, 307, 308, 309, and 310 have product ends 302B, 303B, 304B, 305B, 306B, 307B, 308B, 309B, and 310B, respectively. Product ends 302B, 303B, 304B, 305B, 306B, 307B, 309B, and 310B are connected by lines 314, 315, 316, 317 and 318. Lines connecting product ends 302B, 303B, 304B, 305B, 306B, 307B, 308B, 309B, and 310B with lines 314, 315, 316, 317 and 318 include block valves 319. Lines 314 and 318 are connected with optional product gas buffer tank 319. The product gas buffer tank 321 allows controlled purging and repressurization steps. Product gas 320 can be provided from product gas buffer tank 319 (controlled by a block valve 318).

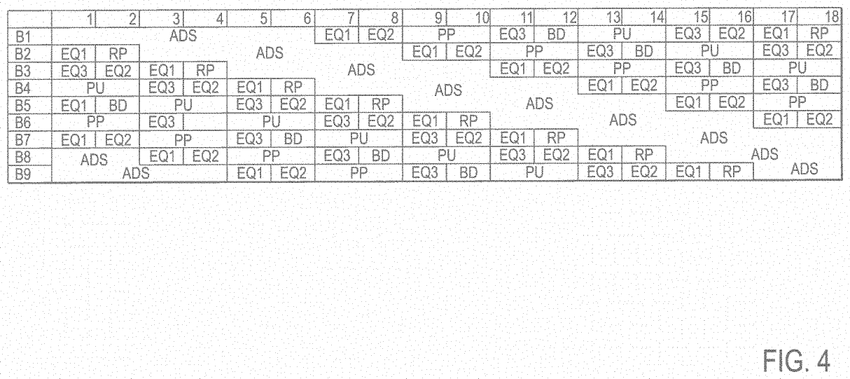

FIG. 4 illustrates the sequence of steps that each of the nine adsorption columns cycles through in an embodiment using the system 300. The cycle of steps that each bed is sequenced through will be described as follows, from the perspective of one of the nine beds, arbitrarily designated herein as the “first bed” or “Bed 1.” Following a first adsorption step (illustrated as “ADS” in the matrix of FIG. 4) in the first bed, a first equalization step (illustrated as “EQ1” in the matrix) occurs in which the first bed is allowed to equalize in pressure with a fifth bed of the nine beds. The fifth bed has a lower pressure than the first bed, so that when the two beds equalize, the pressure of the first bed reduces and the pressure of the fifth bed increases. The equalization can occur through a line connecting the product ends of the first and the fifth beds.

Following the first equalization step, a second equalization step (“EQ2”) occurs in which the first bed is allowed to equalize in pressure with a sixth bed of the nine beds. The sixth bed has a lower pressure than the first bed. The pressure of the first and sixth beds equalizes through a line connecting the product ends of the first and the sixth beds.

Following the above-described second equalization step, the pressure in the first bed is lowered and gas is passed from the first bed to an eighth bed of the nine beds through a line connecting the product ends of the first and the eighth beds. This is referred to as the “providing purge” step (“PP”) since the gas purges the fourth bed.

Following the providing purge step, a third equalization step (“EQ3”) occurs in which the first bed is allowed to equalize in pressure with a eighth bed. The eighth bed has a lower pressure than the first bed. The pressure of the first and eighth beds equalizes through a line connecting the product ends of the first and the eighth beds.

Following the third equalization step, the first adsorbent bed is next depressurized to a pressure of from about 20 to about 1 psia through the feed end of the first adsorbent bed. This is referred to as the blowdown step (“BD”) in which gas in the first adsorbent bed is allowed to vent to a purge tank. Alternatively, a vacuum pump can be used to lower the pressure of the first adsorbent bed in this step.

Following the blowdown step, the first bed is purged in a purging step (“PU”) in which gas is provided to the first bed through the product end of the first bed from another bed of the nine beds while the first bed is at a pressure from about 20 to about 1 psia. Gas is meanwhile purged through the feed end of the first bed during the purging step.

Following the purging step, a fourth equalization step (“EQ3”) occurs in which the first bed is allowed to equalize in pressure with the third bed. The third bed has a higher pressure than the first bed. The pressure equalization can occur through a line connecting the product ends of the first and the third beds.

Following the fourth equalization step, a fifth equalization step (“EQ2”) occurs in which the first bed is allowed to equalize with the fifth bed which has a higher pressure than the first bed. This equalization step can occur through a line connecting the product ends of the first and the fifth beds.

Following the fifth equalization step, a sixth equalization step (“EQ3”) occurs in which the first bed is allowed to equalize with the sixth bed which has a higher pressure than the first bed. This equalization step can occur through a line connecting the product ends of the first and the fifth beds.

Following the sixth equalization step, a slipstream of the product gas is passed through the product end of the first bed to repressurize the first bed to the adsorption step pressure in a repressurization step (“RP”).

Following the repressurization step, the first bed is operated in an independent adsorption step (illustrated as a blank box in the matrix) for sufficient time for the second and seventh beds to be equalized in pressure with respect to one another, for the third and fifth beds to be equalized in pressure with respect to one another, for the sixth bed to be providing purge gas to the fourth bed, and for the eighth and ninth beds to be co-fed feed gas during an adsorption step like the first bed. After this period of time, a second adsorption step can begin for a sufficient time for the second bed is repressurized to the feed pressure of feed gas, for the third and the seventh beds to be equalized in pressure with respect to one another, for the sixth bed to be providing purge gas to the fourth bed, for the fifth bed to be depressurized, and for the eighth and ninth beds to be co-fed feed gas during an adsorption step like the first bed.

The second, third, fourth, fifth, sixth, seventh, eighth and ninth beds are likewise sequenced to cycle through the above-described adsorption step, first equalization step, second equalization step, providing purge step, third equalization step, blowdown step, purging step, fourth equalization step, fifth equalization step, sixth equalization step, repressurization step, and independent adsorption step in the same order as the first bed. In one embodiment, the adsorption step, first equalization step, second equalization step, providing purge step, third equalization step, blowdown step, purging step, fourth equalization step, fifth equalization step, sixth equalization step, repressurization step and independent adsorption step occur in a total cycle time of from 400 to 3600 seconds, even from 400 to 1800 seconds.

In one embodiment, the product gas stream contains at least about 90 mol % of methane recovered from the feed gas stream and at least about 70 mol % of ethane recovered from the feed gas stream.

In one embodiment, recycle of the waste stream from the blowdown and purge steps can be used to increase the CH₄ and C₂H₆ recoveries and lower the vacuum and compression costs. Thus, processes according to some embodiments are suitable for removing acid gases from natural gas streams in remote or off-shore locations if amine absorption is not a viable alternative for separations.

In some embodiments, the methods of the present disclosure have a specific vacuum power consumption of from about 0 to about 1500 kWhr/MM SCF raw gas.

In some embodiments, from greater than 0% to about 50% of the tail gas stream is recycled to the feed gas stream. As a result, a product gas stream is produced containing no greater than about 2 mol % carbon dioxide and at least about 90 mol % of the methane in the feed gas stream and at least about 85 mol % of the total hydrocarbons in the feed gas stream.

In some embodiments, a method is provided for removing acid gas from a feed gas stream of natural gas that includes methane, ethane, carbon dioxide and from 4 to 1000 ppm hydrogen sulfide. The feed gas stream is alternately input between at least two beds (input at a feed end of each bed) of adsorbent particles comprising a zeolite of SSZ-13 such that the feed gas stream contacts one of the at least two beds at a given time in an adsorption step and a tail gas stream is simultaneously vented from another of the at least two beds (from the feed end) in a desorption step. The contact occurs at a feed pressure of from about 50 to about 1000 psia for a sufficient period of time to preferentially adsorb acid gas from the feed gas stream. As a result, advantageously, a product gas stream is produced (removed from a product end of each bed) containing no greater than about 2 mol % carbon dioxide, no greater than about 1 ppm H₂S, and no greater than about 1 ppm COS. At least about 65 mol % of methane is recovered from the feed gas stream and at least about 25 mol % of ethane is recovered from the feed gas stream.

A further embodiment is the use of an intermediate providing purge step rather than at the beginning or end of equilibration steps. The use of the intermediate providing purge led to the best product purity and recovery overall providing an unexpected result since typically running the providing purge before equilibration should give the highest purity and the highest recovery would be after equilibration. The cycle with intermediate providing purge however produced the largest of recovery and purity when it would be expected to be a median of the two extremes. The improvement in product recovery would range by an increase in 3 to 5 percent product recovery for natural gas.

It should be noted that only the components relevant to the disclosure are shown in the figures, and that many other components normally part of a pressure-swing or vacuum-swing adsorption system are not shown for simplicity.

### EXAMPLES

Test Methods

Powder x-ray diffraction (XRD) was performed with Cu X-ray source and measured between 5° and 35° 2-theta (2θ).

BET and t-plot micropore volume were determined by N₂ physisorption experiments. The Na-SSZ-13 samples were activated at 400° C. under flowing N₂ gas. The samples were then cooled to −196° C. and uptake of N₂ was measured.

Pellet density was determined by preparing a volumetric solution of water, submerging Na-SSZ-13 pellets of a known mass into the water solution and calculating density based on changes in volume.

The skeletal density determined from crystal structure of CHA was calculated based on the Si:Al ratio and the sodium cation. The unit cell volume and framework density were obtained from the IZA database.

### Example 1: Preparation of SSZ-13

Na-SSZ-13 powder was synthesized based on previous procedures to produce a CHA (three letter code standing for chabazite, provided by the International Zeolite Association [IZA]) structure with a Si:Al atomic ratio of 6.8 as described in U.S. Pat. No. 6,709,644 (Zones et al.)). Na-SSZ-13 pellets were prepared by mixing with pseudo-Boehmite alumina powder to achieve 25 wt % alumina, grinding the powders together to create a homogeneous mixture and then pressing pellets at 15,000 psi. The alumina binder provides support to the zeolite pellets. The pellets were broken and sieved to obtain the desired mesh size. Multiple pellets were prepared for use in dynamic column breakthrough (DCB) experiments. The Na-SSZ-13 pellet samples were analyzed for BET and t-plot micropore volume analysis following DCB experiments to confirm the adsorbents are fully regenerable and stable after multiple adsorption experiments.

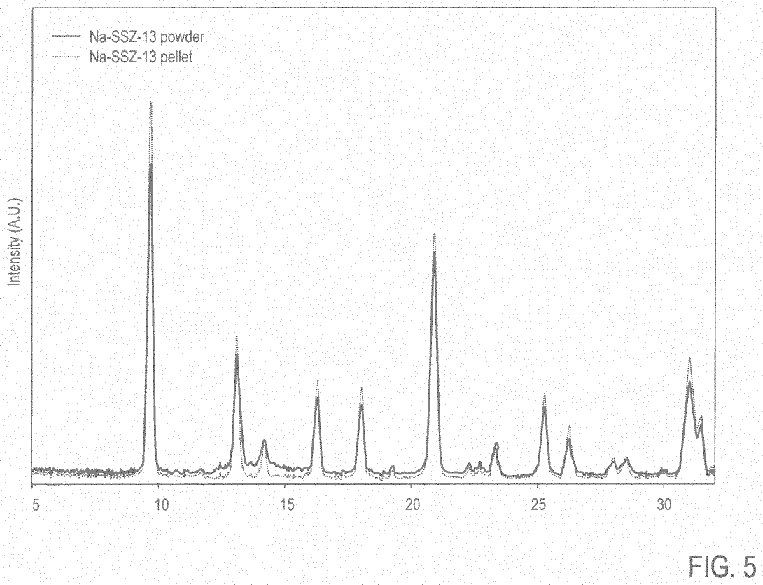

The powder XRD pattern of the Na-SSZ-13 pellet samples is shown in FIG. 5. The XRD pattern matched the expected CHA structure. The CHA structure remained intact after preparing pellets under a high-pressure pellet press, showing the distinct structural peaks between 5-35° (degrees) 2θ (theta). Table 1 shows the characterization of the Na-SSZ-13 powder, pellet and spent pellet. BET and t-plot MPV reflect typical CHA textural properties for Na-SSZ-13 powder. There was no apparent change in the normalized micropore volume when the amount of binder is taken into account, further confirming the CHA structure remained stable after pellet preparation and exposure to different gases at various feed pressures and activation cycles.

TABLE 1

| | Na-SSZ-13 | Na-SSZ-13 | Na-SSZ-13 |
|---|---|---|---|
| | Powder | Pellet | Spent Pellet |
| BET Surface Area | 610 | 530 | 530 |
| (m²/g) | | | |
| t-plot MPV | 0.282 | 0.213 (0.284)^{a} | 0.214 (0.284)^{a} |
| (cm³/g) | | | |

| | |
|---|---|
| Pellet Density | 920 |
| (kg/m³) | |
| Skeletal Density | 1550 |
| (kg/m³) | |

^{a}Values for t-plot MPV in parentheses represented micropore volume normalized to amount of zeolite.

### Example 2: Pure Component Equilibrium Adsorption

Equilibrium gas adsorption experiments for CO₂, CH₄ and C₂H₆ were performed on a SETARAM PCTPro 2000 volumetric system (commercially available from SETARAM INSTRUMENTATION, Caluire, France). Equilibrium vapor adsorption experiments for H₂O were performed on a dynamic vapor sorption (DVS) vacuum gravimetric system (commercially available from SURFACE MEASUREMENT SYSTEMS, London, United Kingdom). Na-SSZ-13 samples were first activated at 250° C. to obtain the dry weight and then reactivated in the gas adsorption system. Gases used were CO₂, CH₄, C₂H₆ and He (all 99.999%). The zeolites were tested from 0-30 bar for CO₂ and CH₄ and 0-3 bar for C₂H₆. For vapor experiments, the pressure ranged up to 280 mbar due to the limitation in generating vapor pressure up to 70° C.

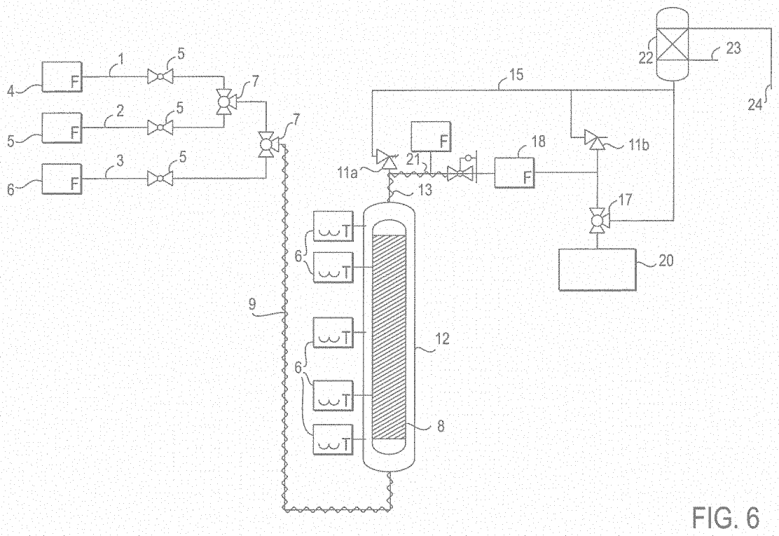

For H₂S adsorption measurements, the adsorption capacity was determined by dynamic column breakthrough (DCB) experiments using the DCB apparatus shown in FIG. 6 and described in Example 3. Gas mixtures of 1000 ppm H₂S in helium were fed to Na-SSZ-13 zeolite pellets at 350 cm³ (STP)/min from pressures of 1.6 to 35 bar to obtain isotherms at different H₂S partial pressures. The capacity was determined by calculating the breakthrough time for H₂S by equation (1).

$${τ}_{b} = {\int }_{0}^{{t}_{∞}} ( 1 - \frac{{F}_{i , o}}{{F}_{i , f}} ) d t \qquad ( 1 )$$

where Fi is the molar flow rate of the gas component being considered at the outlet, o, and feed, f. To determine the breakthrough capacity, the methodology developed by Malek and Farooq in A. Malek, S. Farooq, “Determination of Equilibrium Isotherms Using Dynamic Column Breakthrough and Constant Flow Equilibrium Desorption”, J. Chem. Eng. Data, 1996, 41, 25-32 was used. Using the methodology, the capacity is calculated by equation (2).

$${q}_{b} = \frac{{C}_{i}}{{ρ}_{p}} \frac{{ɛ}_{p}}{1 - {ɛ}_{p}} ( \frac{{v}_{i} {τ}_{b}}{l} - 1 ) \qquad ( 2 )$$

where q_{b} is the breakthrough capacity, Cᵢ is the gas step concentration of component i, ρₚ is the particle density, εₚ is the bed void fraction, vᵢ is the interstitial velocity, l is the length of the packed bed and τ_{b} is the effective breakthrough time.

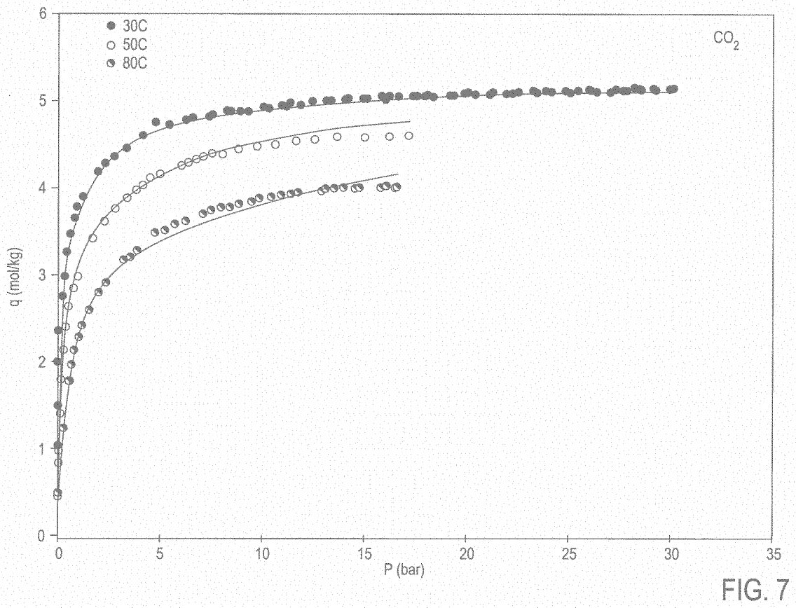

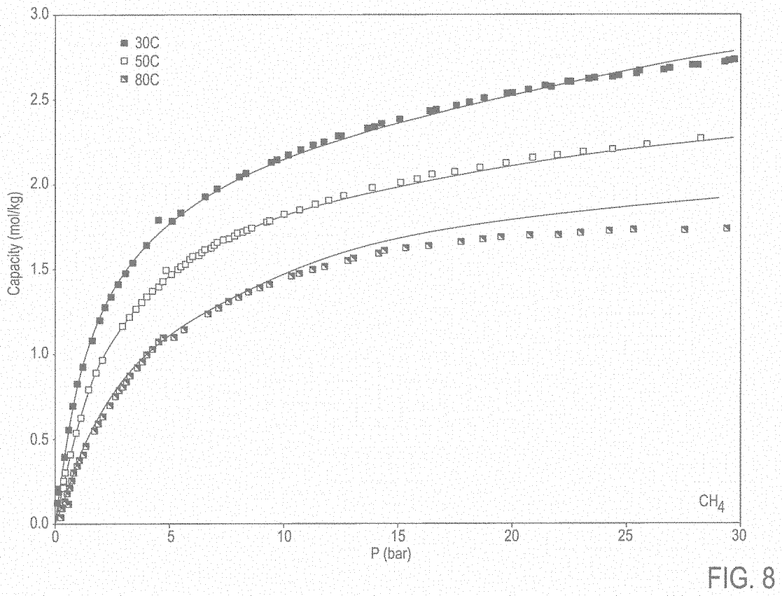

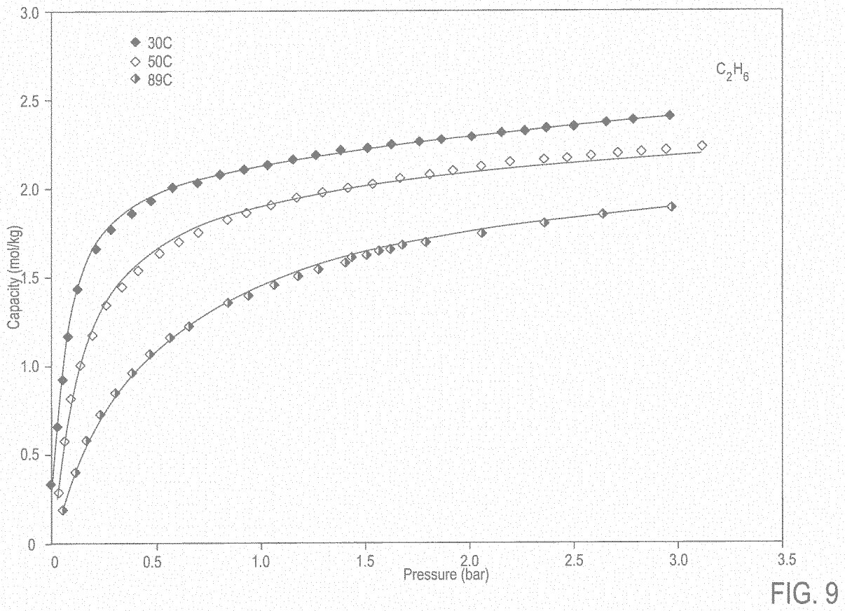

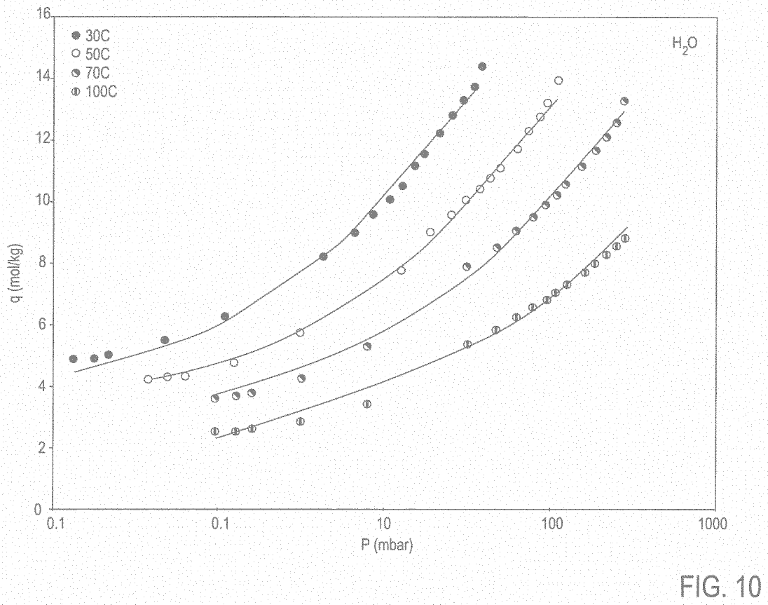

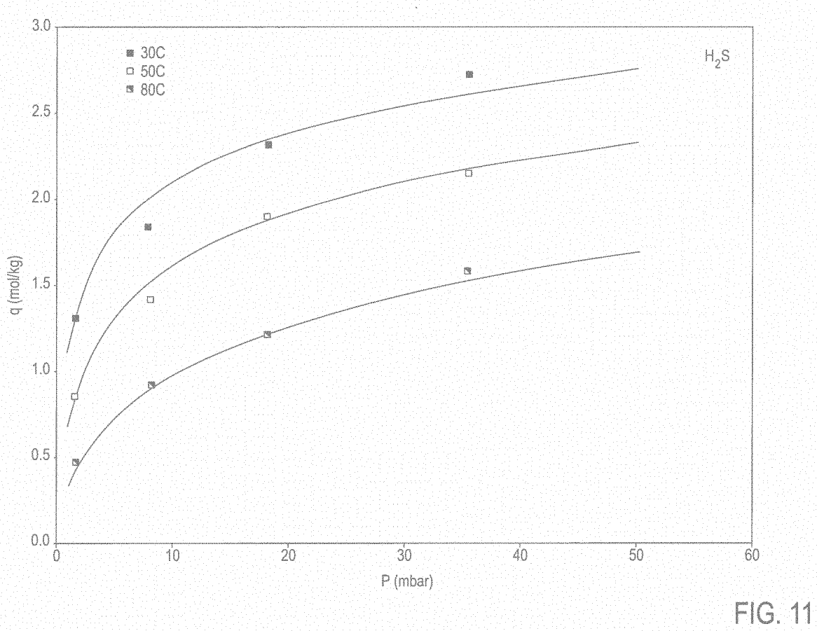

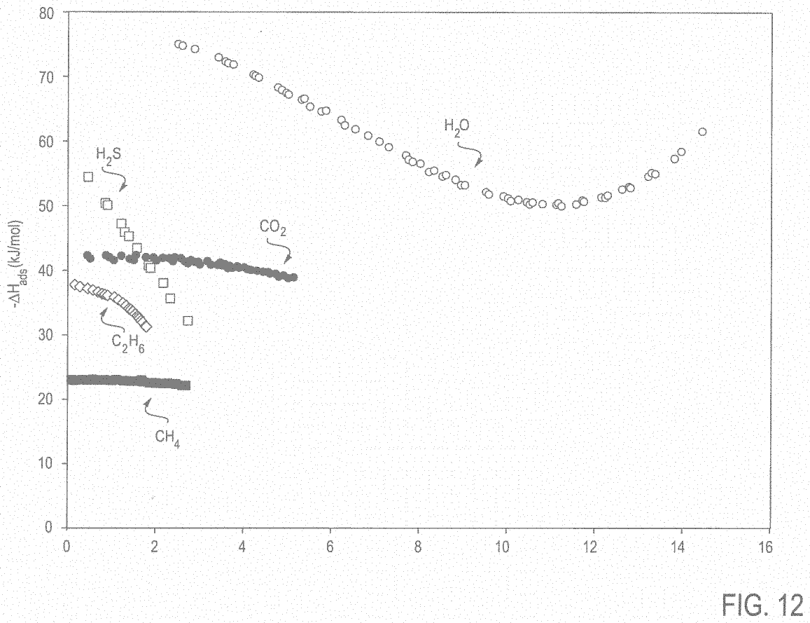

FIGS. 7-11 show the equilibrium adsorption results for CO₂, CH₄, C₂H₆, H₂O and H₂S, respectively. Lines represent the fit of the dual-site Langmuir isotherm equation. FIG. 7 plots CO₂ equilibrium adsorption isotherms at 30-80° C. FIG. 8 plots CH₄ equilibrium adsorption isotherms at 30-80° C. FIG. 9 plots C₂H₆ equilibrium adsorption isotherms at 30-89° C. FIG. 10 plots H₂O equilibrium adsorption isotherms at 30-100° C. FIG. 11 plots H₂S equilibrium adsorption isotherms at 30-80° C. FIGS. 7-11 represent either major hydrocarbon components or major impurities found in natural gas wells with CO₂, CH₄ and C₂H₆ making up 60-90 vol % of most natural gas wells. If an adsorbent is capable of separating CH₄ and C₂H₆ from CO₂, most hydrocarbons may be recovered, especially in application of lean gas mixtures, where very little heavier hydrocarbon components are found. Because the Na-SSZ-13 has a lower amount of aluminum in the zeolite framework, the CO₂ adsorption isotherms do not show saturation at moderate temperatures until the CO₂ pressure reaches above 10 bar. The C₂H₆ adsorption isotherms show much lower saturation pressures with very little increase in adsorbed capacity above 1 bar of pressure. Although the SSZ-13 sample used in this Example has a higher SAR than typical adsorbents, such as zeolites 5A, Na-X or Na-Y, the H₂O adsorption affinity was found to be quite high. Further increasing the SAR may lower the overall affinity for water. The H₂S adsorption isotherms determined from breakthrough experiments showed very high adsorption affinity. The adsorption affinity for Na-SSZ-13 is of the order: H₂O>H₂S>CO₂>C₂H₆>CH₄. The ideal selectivity of both gas pairs, CO₂/C₂H₆ and CO₂/CH₄, is 1.7 and 44 at 30° C. The enthalpy of adsorption for each natural gas component on Na-SSZ-13 is shown in FIG. 12.

Gases with lower molecular weight or lower polarity show significantly lower enthalpies of adsorption compared to components like H₂S and H₂O that have extremely high polarity, and the heat of adsorption correlates with adsorption affinity. For processing natural gas containing these components, it is expected that gas streams containing significant amounts of CO₂, H₂S or H₂O will generate rises in temperature inside the adsorption bed when removing these components during an adsorption cycle.

### Example 3: Dynamic Column Breakthrough (DCB) Adsorption Performance

Dynamic adsorption experiments were carried out on a custom-built DCB apparatus, as shown in FIG. 6. Three lines 1, 2 and 3 were provided for test gases to be fed to the apparatus and metered using mass flow controllers 4. Block valves 5 and switching valves 7 were provided for controlling flow in each line. A line 9 having heat tracing for controlling the temperature within the line delivered the test gases to an adsorption column 8 containing the adsorbent pellets therein. The adsorption column 8 was outfitted with a heater 12, specifically an electrically heated ceramic clamshell heater, and a number of thermocouples 6. Line 13 removed treated gas from the column 8. Line 21 sent the treated gas to a back-pressure regulator 16. Lines 13 and 21 had heat tracing. Pressure transducer 14 monitored the pressure in line 21. Mass flow meter 18 monitored the mass flow in line 21. Relief valves 11 were provided. Line 15 connected the relief valve 11a to a H₂S scrubber 22. Switching valve 17 was provided. Line 19 connected switching valve 17 to the H₂S scrubber 22. The H₂S scrubber 22 separated dilute sulfuric acid 24 from water 23. The mass spectrometer 20 monitored the signal of gases at the following masses: 16 m/z, 18 m/z, 30 m/z, 34 m/z, 44 m/z and 60 m/z for CH₄, H₂O, C₂H₆, H₂S, CO₂ and COS, respectively. For C₂H₆, a mass of 30 m/z was used to avoid interference of CO₂ at 28 m/z and corrected based on the relative signal expected in a C₂H₆ mass spectrum, using a ratio of 26.2% of total C₂H₆. The bulk bed temperature was monitored using two thermocouples 6 at approximately ¼th and ¾th the length of the bed during experiments, and the bed temperature was controlled by an external furnace 12 with three heating zones. The bed temperatures were recorded every 30 s, and maximum temperature at the experimental time for each thermocouple 6 was also recorded. Flow rates were recorded from the mass flow meter (MFM) 18 immediately after the back-pressure regulator 16 and immediately before the mass spectrometer 20. The breakthrough capacity was determined using the methodology described for the H₂S breakthrough capacity experiments.

The dynamic adsorption experiments may be predicted by simulations coupling together momentum, mass and energy balances of a packed bed adsorption column. All simulations were performed using the Aspen Adsorption simulation package from AspenTech (commercially available from Aspen Technology, Inc., Bedford, Mass.). The adsorption kinetics were assumed to occur by the Linear Driving Force (LDF) mechanism as described in D. M. Ruthven, Principles of Adsorption and Adsorption Processes, John Wiley & Sons, Inc. New York, 1984, according to equation (3).

$$\frac{\partial \overline{{q}_{i}}}{\partial t} = {k}_{i} ( {q}_{i} - {\overline{q}}_{i} ) \qquad ( 3 )$$

where qᵢ is the adsorbed-phase concentration and kᵢ is the lumped mass transfer coefficient for component i. Depending on the conditions of the adsorption and desorption processes, the micropores of the zeolites and the macropores of the pellets may influence the adsorption kinetics. In order to account for these possible adsorption kinetics and any film resistances that occur on the pellet surface, a lumped mass transfer coefficient was determined from the following correlation as described in D. M. Ruthven, S. Farooq, K. S. Knaebel, Pressure Swing Adsorption, John Wiley & Sons, Inc. New York, 1994, according to equation (4).

$$\frac{1}{{k}_{i}} = \frac{{r}_{p}}{3 {k}_{f , i}} \frac{{q}_{f , i}}{{C}_{f , i}} + \frac{{r}_{p}^{2}}{15 {ɛ}_{i} {D}_{p , i}} \frac{{q}_{f , i}}{{C}_{f , i}} + \frac{{r}_{c}^{2}}{15 {D}_{c , i}} \qquad ( 4 )$$

where k_{f} is the film mass transfer coefficient, rₚ is the pellet radius, q_{f,i} and C_{f,i} are the adsorbed- and gas-phase concentrations of component i at the feed conditions, εᵢ is the intraparticle void fraction, D_{p,i} is the effective macropore diffusivity, r_{c} is the crystal radius and D_{c,i} is the crystal diffusivity. Typically, the film resistance is negligible if the macropore and micropore resistances are much slower or higher flow rates of gas are used. The effective macropore diffusivity was determined by a combination of molecular diffusion and Knudsen diffusion as described in A. L. Hines, R. N. Maddox, Mass Transfer: Fundamentals and Applications, Prentice Hall, Inc. Engelwood Cliffs, N.J., 1985, according to equations (5) and (6).

$$\begin{matrix}{D}_{k , i} = 4500 {d}_{m o c r o} \sqrt{\frac{T}{{M}_{i}}} & ( 5 ) \\ \frac{1}{{D}_{p , i}} = τ ( \frac{1}{{D}_{k , i}} + \frac{1}{{D}_{m , i}} ) & ( 6 )\end{matrix}$$

where D_{k,i} is the Knudsen diffusivity, d_{macro} is the pore diameter of the macropores, and τ is the tortuosity, often assumed to be between 2 and 3. Finally, because the Na-SSZ-13 crystals produced in Example 1 are relatively small, the crystal, or micropore, diffusivity was assumed to be negligible.

In order to predict the adsorption behavior in multicomponent feeds, Ideal Adsorbed Solution Theory (IAST) was used to predict the mixture adsorption properties by using models that accurately describe the pure component adsorption properties, as described in A. L. Myers, J. M. Prausnitz, “Thermodynamics of Mixed-Gas Adsorption”, AIChE J., 1965, 11, 121-127. IAST has been shown to be reasonably accurate for predicting gas mixture adsorption behavior in zeolite materials with CO₂ in the feed, as described in L. Ohlin, M. Grahn, “Detailed Investigation of the Binary Adsorption of Carbon Dioxide and Methane in Zeolite Na-ZSM-5 Studied using In-Situ ATR-FTIR Spectroscopy”, J. Phys. Chem. C, 2014, 118, 6207-6213.

### DCB Experimental and Simulation Results

In order to understand the adsorption mechanism and behavior of gas mixtures in a packed bed adsorption column, dynamic adsorption studies studying breakthrough curves are commonly used to assess the performance of different adsorbent materials. Although most studies examine the system response of the adsorbent when gas is introduced to a clean bed (pre-loaded with He, for instance), the experiments disclosed herein have examined the system response to introducing CO₂ and C₂H₆ to a packed bed already containing CH₄. To simulate the breakthrough curves, the adsorbent equilibrium, kinetic and physical properties have been determined by data from Example 2 and correlations and equations known in the prior art.

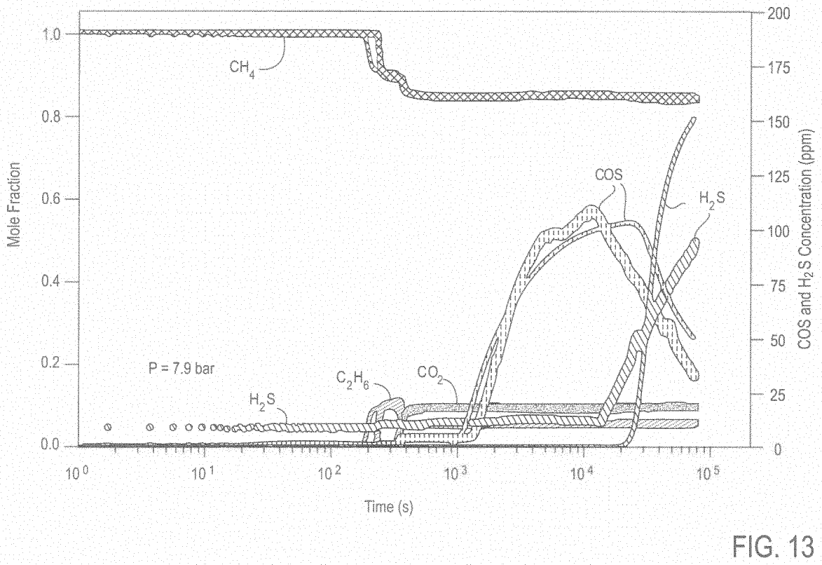

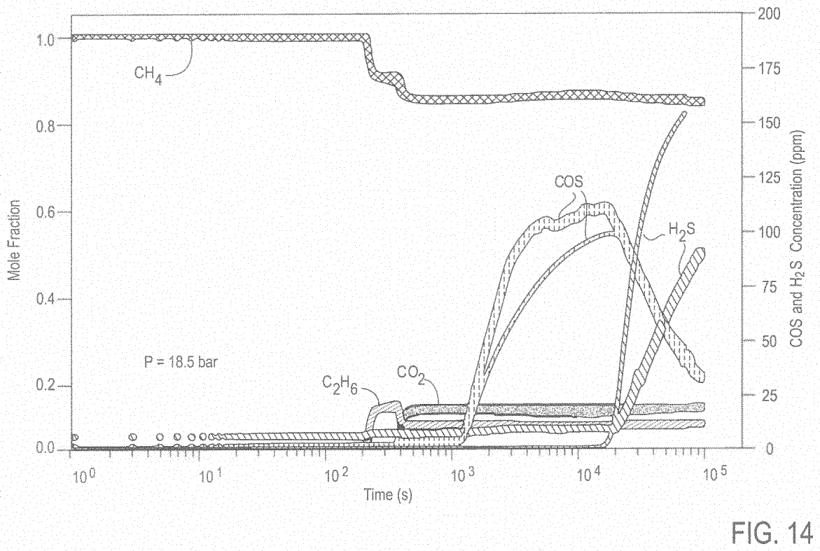

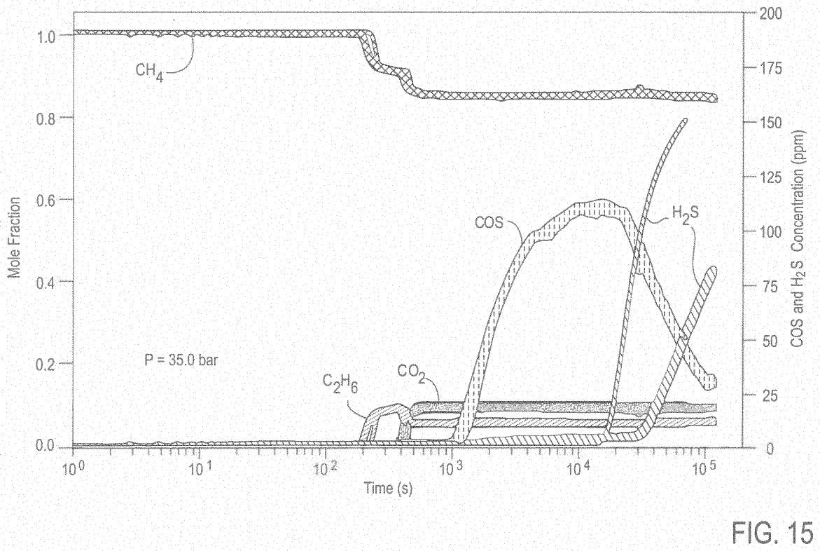

Representative breakthrough curves for Na-SSZ-13 are shown in FIGS. 13-15 for gas feeds that contain the following composition: 10 mol % CO₂, 5 mol % C₂H₆, 250 ppm H₂S, and balance of CH₄. The breakthrough profile for C₂H₆ shows what is known in prior art as “roll-up” effect, where there is temporary enrichment of C₂H₆ compared to the feed composition. The roll-up shown in these data indicate the enrichment is caused by favorable adsorption of CO₂ over C₂H₆, a desirable adsorption property for a natural gas adsorbent. Because other adsorbent materials have demonstrated the ability to drive the equilibrium of H₂S and CO₂ towards COS and H₂O the concentration breakthrough profiles of these impurities are also shown. It is well known in prior art that under equilibrium conditions of:

$${CO}_{2} + {H}_{2} S {↔}^{ {K}_{eq }} COS + {H}_{2} O$$

COS and H₂O will exist in very small concentrations relative to H₂S and CO₂. In FIGS. 13-15, both COS and H₂O are found in concentrations above the expected equilibrium value of 5 ppm, given the feed concentration of CO₂ and H₂S. A significant advantage of Na-SSZ-13 over other adsorbents in the prior art is the sharp separation between COS and CO₂ in the product end of the bed. Because enriched natural gas has strict requirements on H₂S and COS in the pipeline specifications, the ability to separate CO₂ and COS poses an advantage over traditional zeolite adsorbent materials, such as zeolites 5A, Na-X and Na-Y that have lower silica-to-alumina ratios (SAR) and typically high affinity for H₂O and/or COS. Owing to the higher SAR in Na-SSZ-13, the formation of COS and H₂O is less than expected for an aluminosilicate zeolite, and purification of hydrocarbons from these impurities, which include CO₂, H₂S, H₂O and COS, can be achieved by a pressure-swing or temperature-swing adsorption process or a combination of these processes. The lines shown in these figures represents an adsorption model using Ideal Adsorbed Solution Theory to predict the mixture adsorption properties of Na-SSZ-13. In addition, a reaction model is used to account for the conversion between CO₂ and H₂S to COS and H₂O. As shown the developed model accurately describes the adsorption breakthrough profile for Na-SSZ-13 under conditions that contain both H₂S and CO₂ by taking the reaction into account for the adsorption modeling.

### Example 4: 9-Bed Pressure-Swine Adsorption Process Performance

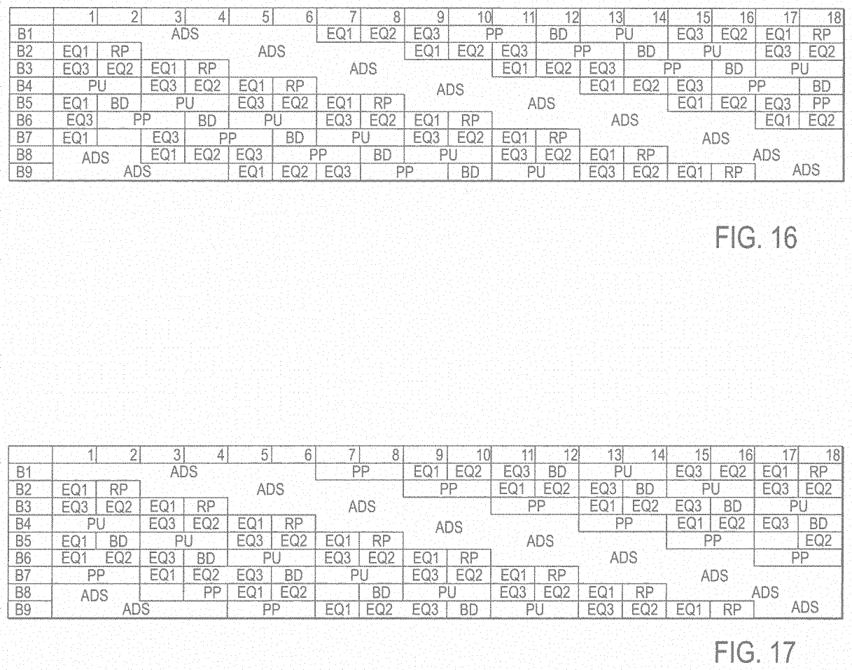

Pressure-swing and vacuum-swing adsorption modeling provides a target for actual process performance by predicting the expected hydrocarbon recovery and CO₂ removal for natural gas separations. The PSA simulations are used here to demonstrate capability of the Na-SSZ-13 adsorbent to achieve greater than 90 mol % CH₄ recovery in a natural gas stream with typical feed conditions for natural gas processing. The PSA simulation is set up with the bed initially saturated with the feed gas at the feed pressure. Once the cyclic steady-state has been determined by monitoring both the mass and thermal balance between cycles, the simulation is stopped, and all necessary parameters are recorded. The simulation takes between 100-1000 cycles to reach steady-state, depending on the process parameters being examined. The simulation approach uses a data buffer strategy combined with a single bed to simulate the effect of changing gas concentrations entering and exiting the adsorbent bed. The PSA process with a 2 bed system may look like the process diagram shown in FIG. 1 with an adsorption cycle as shown in FIG. 2. Initial PSA simulations for Na-SSZ-13 showed maximum recoveries of CH₄ and C₂H₆ to be 65% and 25%, respectively, when using 2-bed PSA cycle. Adsorption cycles utilizing 9 beds are summarized in FIGS. 3-4 and FIGS. 16-17 and are the basis of the PSA process examined in this Example, showing an improvement over the 2-bed process. The step configuration for the first 9 bed cycle was adopted from prior art using PSA separation for H₂ purification; however, this PSA configuration has not been examined before for natural gas separations. In addition, other 9-bed PSA cycles are examined to demonstrate process trade-offs and advantages based on the cycle order for a 9-bed PSA system. The total cycle time in this Example was fixed at 1800 s with the adsorption time fixed at 600 s. By having the adsorption time at ⅓rd of the total cycle time and the feed split between three individual beds, a continuous production of natural gas may be expected during operation. The operational parameters examined in this Example are the effects of: Feed Flowrate (MMSCFD) and the cycle order (summarized in FIGS. 4 and 16-17). The three parameters used to assess the cyclic performance for each PSA process configuration are:

$${CO}_{2} Content = \frac{{\int }_{0}^{{t}_{A D S}} {C}_{{CO}_{2}} u {\vert}_{z = l} d t}{\sum {\int }_{0}^{{t}_{A D S}} {C}_{i} u {\vert}_{z = l} d t}$$

$${H}_{2} S Content = \frac{{\int }_{0}^{{t}_{A D S}} {C}_{{H}_{2} S} u {\vert}_{z = l} d t}{\sum {\int }_{0}^{{t}_{A D S}} {C}_{i} u {\vert}_{z = l} d t}$$

$$C {H}_{4} Recovery = \frac{{\int }_{0}^{{t}_{A D S}} {C}_{C {H}_{4}} u {\vert}_{z = l} d t - {\int }_{0}^{{t}_{R P}} {C}_{C {H}_{4}} u {\vert}_{z = l} d t}{{\int }_{0}^{{t}_{A D S}} {C}_{C {H}_{4}} u {\vert}_{z = 0} d t}$$

where the integral represents the time-averaged moles consumed or produced for each component. The target CO₂ content for this Example is pipeline specification, 2 mol % CO₂, and the target H₂S content is 4 ppm H₂S.

Considering the relatively lower CH₄ recovery of a 2-bed PSA process, increasing the number of beds will improve recovery. The order in which the PSA cycle is performed can affect the potential product recovery and separation targets for CO₂ and H₂S removal. First, all three 9-bed PSA processes are compared under the same pressure and feed flowrate of 75 bar and 160 MMSCFD, respectively, with a feed composition of: 0.1 mol % C₂H₆, 8.1 mol % CO₂, 0.4 mol % N₂, 0.0947 mol % H₂O, 40 ppm H₂S and balance of CH₄. This represents a water-saturated natural gas stream containing both CO₂ and H₂S with removal targets of 75% and 90% for CO₂ and H₂S, respectively. As shown in FIGS. 4 and 16-17, the three 9-bed PSA processes only differ in the placement of the providing purge step relative to the equalization steps during the cycle. By changing the placement of this providing purge step, the amount of CH₄ recovery and CO₂ and H₂S separation will trade off. The results summarized in Table 2 demonstrate the capability of the 9-bed PSA process to meet CO₂ separation targets under certain conditions. In all cases, despite the reaction considered for the PSA process, the COS content is shown to be less than 1 ppb for all three processes. This suggests that the cycle time selected is appropriately short enough to get high CH₄ recovery while preventing formation of COS and infiltration into the product gas. Even though previous work had suggested that moving the providing purge step prior to equalization steps would result in more separation with less product recovery, the results using this adsorbent show the recovery to actually increase while achieving better separation performance by moving the providing purge step in the PSA cycle.

TABLE 2
Summary of 9-bed PSA process performance
using Na-SSZ-13 adsorbent.

| | CO₂ | H₂S | COS | |
|---|---|---|---|---|
| | Product | Product | Product | CH₄ |
| Process | Content | Content | Content | Recovery |
| Number | (mol %) | (ppm) | (ppm) | (%) |
| 1 | 2.12 | 0.25 | <0.001 | 86.79 |
| 2 | 1.04 | 0.19 | <0.001 | 87.62 |
| 3 | 0.73 | 0.15 | <0.001 | 87.68 |

As Process 2 and Process 3 demonstrated the highest separation performance in terms of CO₂ and H₂S removal and CH₄ recovery, these processes are further investigated. Results summarized in Table 3 show Process 2 is capable of reaching the largest CH₄ recovery over the other two 9-bed PSA processes while also meeting the CO₂ and H₂S removal criteria.

TABLE 3
Summary of different process conditions
for the 9-bed PSA Process 2 and 3.

| | | CO₂ | H₂S | COS | |
|---|---|---|---|---|---|
| | | Product | Product | Product | CH₄ |
| Process | Flowrate | Content | Content | Content | Recovery |
| Number | (MMSCFD) | (mol %) | (ppmv) | (ppmv) | (%) |
| 1 | 192 | 1.95 | 0.43 | <0.001 | 91.50 |
| | 240 | 3.52 | 1.15 | <0.001 | 90.96 |
| 2 | 192 | 1.49 | 0.63 | <0.001 | 88.21 |
| | 240 | 2.91 | 0.96 | <0.001 | 88.53 |

The present disclosure provides a process to separate natural gas products from acid gases without the need for solvent regeneration or dehydration processes. The reduction in process complexity enables gas processing in remote or off-shore locations where natural gas may contain significant amounts of acid gases by reducing multiple solvent-based process units to a more compact adsorbent-based process unit. In addition, the zeolite SSZ-13 adsorbent PSA simulations predict a substantially higher recovery of hydrocarbons and a 25% reduction in required power consumption when no recycle stream is used compared to existing commercial technologies for PSA processes.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

From the above description, those skilled in the art will perceive improvements, changes and modifications, which are intended to be covered by the appended claims.

What is claimed is:

1. A method for removing acid gas from a feed gas stream of natural gas including acid gas, methane and ethane, comprising:
alternating input of the feed gas stream between at least two beds of adsorbent particles comprising a zeolite of either SSZ-13 or some combination such that the feed gas stream contacts one of the at least two beds at a given time in an adsorption step and a tail gas stream is simultaneously vented from another of the at least two beds in a desorption step;
wherein the contact occurs at a feed pressure of from about 50 to about 1000 psia for a sufficient period of time to preferentially adsorb acid gas from the feed gas stream; thereby producing a product gas stream containing no greater than about 2 mol % carbon dioxide and at least about 65 mol % of methane recovered from the feed gas stream and at least about 25 mol % of ethane recovered from the feed gas stream; and
wherein the feed gas stream is input at a feed end of each bed; the product gas stream is removed from a product end of each bed; and the tail gas stream is vented from the feed end of each bed.

2. The method of claim 1, wherein the at least two beds of adsorbent particles comprising a zeolite of SSZ-13 or some combination are nine beds of adsorbent particles comprising zeolite SSZ-13; and wherein the product gas stream contains at least about 90 mol % of methane recovered from the feed gas stream and at least about 70 mol % of ethane recovered from the feed gas stream.

3. The method of claim 1, wherein the acid gas adsorbed from the feed gas stream comprises carbon dioxide and from 0 to 1000 ppm hydrogen sulfide.

4. The method of claim 1, wherein the zeolite SSZ-13 has a Si:Al ratio of from 5 to 100.

5. The method of claim 1, wherein the feed gas stream has a flow rate of from 1 to 300 MMSCFD in the adsorption step and the adsorption step occurs at a temperature of from 10 to 80° C.

6. The method of claim 1, wherein the product gas stream contains methane having a purity of at least about 95 mol % and ethane having a purity of at least about 3 mol % ethane.

7. The method of claim 1, wherein the product gas stream contains no greater than about 50 ppm hydrogen sulfide.

8. The method of claim 1, wherein the product gas stream contains no greater than about 4 ppm hydrogen sulfide.

9. The method of claim 1, wherein the zeolite SSZ-13 has a cation as a framework ion selected from the group consisting of sodium, calcium, potassium, lithium, magnesium, and barium.

10. The method of claim 1, wherein the zeolite SSZ-13 has sodium as a framework ion.

11. The method of claim 1, wherein the acid gas is a gas selected from the group consisting of carbon dioxide, hydrogen sulfide, carbonyl sulfide, combinations thereof, and combinations thereof with water.

12. The method of claim 1, wherein the method utilizes two beds of adsorbent particles comprising a zeolite of SSZ-13 or some combination and further comprising:
a. following the adsorption step in one of the two beds and simultaneous desorption step in the other of the two beds, equalizing pressure of the two beds through the product end of each of the two beds at the end of the adsorption step and simultaneous desorption step; and
b. repressurizing the bed having just completed the desorption step by sending a slipstream of the product gas stream through the product end of the bed having just completed the desorption step.

13. The method of claim 1, wherein the at least two beds of adsorbent particles comprising a zeolite of SSZ-13 or some combination are nine beds of adsorbent particles comprising a zeolite of SSZ-13; further comprising:
a. following a first adsorption step in a first bed of the nine beds, a first equalization step occurs wherein the first bed is allowed to equalize in pressure with a fifth bed of the nine beds having a lower pressure than the first bed through a line connecting the product ends of the first and the fifth beds;
b. following the first equalization step, a second equalization step occurs wherein the first bed is allowed to equalize in pressure with a sixth bed of the nine beds having a lower pressure than the first bed through a line connecting the product ends of the first and sixth beds;
c. following the second equalization step, lowering pressure in the first bed and passing gas from the first bed to an eighth bed of the nine beds through a line connecting the product ends of the first and the eighth beds in a providing purge step such that the eighth bed of the nine beds is purged;
d. following the providing purge step, a third equalization step occurs wherein the first bed is allowed to equalize in pressure with the eighth bed of the nine beds having a lower pressure than the first bed through a line connecting the product ends of the first and the eighth beds;
e. following the third equalization step, depressurizing the first adsorbent bed to a pressure from about 20 to about 1 psia through the feed end of the first adsorbent bed in a blowdown step comprising either:
i. allowing gas in the first adsorbent bed to vent to a purge tank; or
ii. using a vacuum pump to lower the pressure of the first adsorbent bed;
f. following the blowdown step, the first bed is purged in a purging step wherein gas is provided to the first bed through the product end of the first bed from a fourth bed of the nine beds while the first bed is at a pressure from about 20 to about 1 psia and gas is purged through the feed end of the first bed;
g. following the purging step, a fourth equalization step occurs wherein the first bed is allowed to equalize in pressure with the third bed having a higher pressure than the first bed through a line connecting the product ends of the first and the third beds;
h. following the fourth equalization step, a fifth equalization step occurs wherein the first bed is allowed to equalize with the fifth bed having a higher pressure than the first bed through a line connecting the product ends of the first and the fifth beds;
i. following the fifth equalization step, a sixth equalization step occurs wherein the first bed is allowed to equalize with the sixth bed having a higher pressure than the first bed through a line connecting the product ends of the first and the sixth beds;
j. following the sixth equalization step, passing a slipstream of the product gas or a stream of gas from a storage tank through the product end of the first bed to repressurize the first bed to the adsorption step pressure in a repressurization step; and
k. following the repressurization step, operating the first bed in an independent adsorption step for sufficient time for the third and fifth beds to be equalized in pressure, the second and the seventh beds to be equalized in pressure, the sixth bed providing purge gas to the product end of the fourth bed, and the eighth and ninth beds to be co-fed feed gas operating in an adsorption step like the first bed;
wherein the second, third, fourth, fifth, sixth, seventh, eighth, and ninth beds are sequenced to cycle through the adsorption step, first equalization step, second equalization step, providing purge step, third equalization step, blowdown step, purging step, fourth equalization step, fifth equalization step, sixth equalization step, product-end repressurization step and independent adsorption step in the same order as the first bed.

14. The method of claim 13, wherein the adsorption step, first equalization step, providing purge step, second equalization step, blowdown step, purging step, third equalization step, fourth equalization step and independent adsorption step occur in a total cycle time of from 400 to 3600 seconds.

15. The method of claim 1, wherein the method is performed on an offshore platform.

16. The method of claim 1, wherein the method has a specific vacuum power consumption of from about 0 to about 1500 kWhr/MM SCF raw gas.

17. The method of claim 1, wherein from greater than 0% to about 50% of the tail gas stream is recycled to the feed gas stream; thereby producing a product gas stream containing no greater than about 2 mol % carbon dioxide and at least about 90 mol % of the methane in the feed gas stream and at least about 85 mol % of the total hydrocarbons in the feed gas stream.

18. A method for removing acid gas from a feed gas stream of natural gas including methane, ethane, carbon dioxide and from 4 to 1000 ppm hydrogen sulfide, comprising:
alternating input of the feed gas stream between at least two beds of adsorbent particles comprising a zeolite of SSZ-13 or some combination such that the feed gas stream contacts one of the at least two beds at a given time in an adsorption step and a tail gas stream is simultaneously vented from another of the at least two beds in a desorption step;
wherein the contact occurs at a feed pressure of from about 50 to about 1000 psia for a sufficient period of time to preferentially adsorb acid gas from the feed gas stream; thereby producing a product gas stream containing no greater than about 2 mol % carbon dioxide, no greater than about 1 ppm H₂S, no greater than about 1 ppm COS, and at least about 65 mol % of methane recovered from the feed gas stream and at least about 25 mol % of ethane recovered from the feed gas stream; and
wherein the feed gas stream is input at a feed end of each bed; the product gas stream is removed from a product end of each bed; and the tail gas stream is vented from the feed end of each bed.
